(19) United States
(12) Patent Application Publication
(10) Pub. No.: US 2003/0062426 A1
(43) Pub. Date: Apr. 3, 2003

(54) Shower handset

(76) Inventors: George Richard Gregory, Lechworth Herts (GB); Peter Cauwood, Cambridge (GB); Steve Brace, Cambs (GB); Peter Georg Laitenberger, Cambridge (GB)

Correspondence Address: GLENN PATENT GROUP, 3475 EDISON WAY, SUITE L, MENLO PARK, CA, 94025, US

(21) Appl. No.: 10/234,928

(22) Filed: Sep. 4, 2002

(30) Foreign Application Priority Data
Sep. 4, 2001 (GB) 0121377.6

(51) Int. Cl. F23D 11/34; B05B 15/02

(52) U.S. Cl. 239/107; 239/108; 239/115; 239/437; 239/533.1; 239/533.13; 239/533.14; 239/DIG. 12; 239/558

(57) ABSTRACT

A shower handset having teats formed in an elastomeric plate wherein positioning of the elastomeric plate behind the spray plate causes the teats to deflect outwardly, the cross-sectional areas of outlet orifices increasing in response to increasing flow rate.

### BACKGROUND OF THE INVENTION

1. Field of the Invention

The present invention relates to a shower handset, in particular, a shower handset for coping with different water flow rates and providing an improved construction.

2. Description of the Related Art

Typically, a shower handset includes a spray plate having a plurality of orifices for providing an outlet spray pattern.

Various patterns are known and, indeed, it is known to provide handsets having a plurality of different spray patterns from which the user may choose.

Shower handsets may include simple holes, either round or elongated, in the spray plate or may include so called elastomeric teats to form the spray pattern. Elastomeric teats can easily be cleaned (from limescale and other deposits) by manually rubbing and deforming the teats. Current teats are typically cone-shaped and consist of rubber or a rubber-like material. On the other hand, holes in a spray plate are easier to manufacture, but suffer the disadvantage of being hard to clean from scale and other deposits. However, in this regard, pins may be provided internally of the handset for insertion through the holes to clean them. The pins may be operated manually or as part of the operation of changing spray patterns.

### OBJECTS OF THE INVENTION

The present invention is based on a recognition of a problem with previous handsets. In particular, where a handset is used with a flow rate less than normal, the jets of the spray pattern are soft and droop due to the fact that the orifices are too large for the chosen flow rate. On the other hand, for higher than normal flow rate, the handset introduces an unnecessarily large pressure drop and the jets become undesirably hard. In this respect, it should be appreciated that the handset of a shower is usually the main contributor to the overall showery's pressure drop and will often limit the performance of the total shower system, whether this includes a mixer valve, an instantaneous electric shower heater etc.

The problem identified above could be overcome by providing handsets and spray plates which are optimised for particular flow rates. However, it is sometimes the case that a particular installation will have to cope with varying flow rates. In particular, for an instantaneous electric shower heater, the temperature is usually controlled by varying the flow rate through the heater. This means that, when the user chooses/selects a colder showering temperature, eg. in summer, where little heating is required, the flow rate is very high, for instance 15 litres per minute, whereas, when the user chooses/selects a hotter showering temperature, eg. in winter, where a lot of heating is required, the flow rate is relatively low, for instance 3 litres per minute.

Previous shower handsets and spray plates do not cope adequately with this range of flow rates. Typically, soft and drooping jets are produced during winter for the lower flow rates. Indeed, typical handsets have relatively large pressure drops at high flow rates and therefore limit the flow rate through the shower unit.

It is an object of the present invention to overcome the problems as identified above.

The present application also recognises for the first time the desirability of providing a spray pattern which diverges from the spray plate of the handset and problems in implementing this when using elastomeric teats. The present invention is based on a recognition of problems relating to the moulding and assembly of components which provide the diverging spray pattern. In particular, when a component is moulded using straight forward moulding techniques, it is necessary to separate the two halves of the mould tool and, hence, it becomes necessary for all of the orifices forming the jets to have parallel sides or diverge with respect to the line of draw. To construct a shower handset with a diverging spray pattern, it would be possible to mould elastomeric teats separately and to assemble them in the spray plate such that the diverging pattern is formed. However, this adds significantly to the complexity and cost of assembly. It is therefore desirable to be able to mould all of the elastomeric teats together as a single component. While it is possible to mould all the teats together on a teat mat at the same time, this design, however, requires all teats to be different and the shape of each teat to be adjusted according to its position on the mat.

### SUMMARY OF THE INVENTION

According to the present invention, there is provided a shower handset having an inlet for water and at least one orifice for providing an outlet spray pattern wherein the flow resistance of the orifice changes automatically in response to the flow rate.

This could be achieved by varying the shape and/or length of the orifice, but preferably the cross-sectional area of the orifice changes automatically in response to the flow rate.

In particular, the cross-sectional area increases with increasing flow rate.

In this way, the present invention may provide a nozzle which automatically changes the size of the orifice as a function of the flow rate and therefore achieves an optimal performance and appearance over a wider range of flow rates. Changing the size of the orifice as a function of the flow rate will enable the pressure drop across the aperture to be tailored to suit the requirements of the particular shower system. For example, in comparison to a previous handset, the handset according to the present invention will significantly reduce the pressure drop across the handset at high flow rates while providing an aesthetically acceptable spray pattern at low flow rates.

In order to combine these two characteristics in one spray plate, the size and/or shape of the holes in the plate is varied as a function of flow rate. At low flow rates the holes are sufficiently small to enable the formation of well defined jets which are aesthetically pleasing. In contrast, at higher flow rates, the hole diameter is bigger so that a low pressure drop can be achieved across the spray plate.

At least one of the orifices may include an elastomeric teat having an outlet at one end.

In this way, benefits of rub-clean designs may be incorporated. However, the elastomeric teats need not be of a form suitable for rub-clean operation, since they have other benefits to be discussed below.

The elastomeric teat may include a peripheral wall defining a generally conical inner passageway feeding the outlet and having a progressively reduced cross-sectional area towards the one end.

In this way, the outlet from the elastomeric teat, in its relaxed state at least, has a smaller cross-sectional area than its inlet.

The peripheral wall may include a plurality of slits extending axially from the outlet so as to define a plurality of interspersed flaps which deflect outwardly with increasing water flow rate.

In this way, for higher flow rates, the flaps are deflected so as to produce a larger outlet, thereby maintaining the desired spray pattern and preventing an undue pressure drop.

Alternatively, the peripheral wall may include a plurality of folds extending axially from the outlet such that, with increasing water flow rate, the cross-sectional area of the outlet and the peripheral wall proximate the outlet increase.

Thus, the wall has a flexible concertina construction such that, as the flow rate increases, the wall flexes apart so as to increase the cross-sectional area of the outlet. In this way, the desired spray pattern is maintained and an undue pressure drop is avoided.

The peripheral wall may have a relatively reduced thickness such that, with increasing water flow rate, the peripheral wall flexes outwardly and the cross-sectional area of the outlet increases.

Thus, in the same way as above, the spray pattern may be maintained and an undue pressure drop avoided.

The outlet may be at least partly covered by a plurality of inwardly extending flexible flaps which flex away from the outlet with increasing flow rate so as to increase the cross-sectional area of the outlet flow path. Indeed, the orifice may be provided with such flaps in place of a teat.

In this way, the effective water outlet is defined by the area left between the flaps. Hence, for small flow rates, the flaps remain relatively undeflected, thereby defining a relatively small effective outlet cross-sectional area. On the other hand, as the flow rate increases, the flaps will be deflected so as to define a larger effective outlet cross-sectional area. Thus, generally the same spray pattern may be maintained for all flow rates and an undue pressure drop may be avoided for high flow rates.

Preferably, three inwardly extending flexible flaps are provided symmetrically for each outlet separated by three radial slits meeting at the centre of the outlet.

The use of three flaps is particularly advantageous, because of reasons of manufacturability to be discussed further below. In particular, it becomes easier to mould teats together integrally on a plate without air pockets being formed in the flaps of the teats.

It should be appreciated that the flexibility/spring constant can be adjusted by varying the number of flaps and, in effect, the width of a flap.

The flexibility of the flaps can also be adjusted by changing the thickness, material hardness and/or geometry. Also, structures, such as ribs and indentations may be included in the flap design to tailor the spring constant.

Preferably, the teats extend from a common base, the base being integral with the teats.

Preferably, to give the desired flexibility, the teats and base are made of a material which is as soft as possible. A suitable material is liquid silicone. Due to practical restrictions and the need to provide teats which are durable, the Shore hardness of the material is preferably in the range of 30 to 60. In particular, materials having a Shore hardness in the region of 40 have been found to be particularly advantageous.

Preferably at least one of the orifices includes a pin within the handset, the pin being movable into and out of the orifice in response to flow rate.

It should be appreciated that moving the pin into the orifice will restrict flow of water through the orifice.

Preferably, the pin moves progressively into the orifice with decreasing flow rate.

In this way, as the flow rate increases, the effective orifice cross-sectional area is increased, thereby maintaining generally a constant spray pattern and avoiding an unnecessary pressure drop.

The pin may be moved by means of a diaphragm within the handset which deforms as a function of flow rate.

At least one of the pin and the orifice may be tapered.

This may be used to improve the ability of the pin to adjust the effective orifice cross-sectional area.

According to the present invention, there is also provided a shower teat plate for use in a shower handset, the plate including a base and a plurality of teats extending from the base, each teat having an outlet at the end distal from the base. The outlet is at least partly covered by a plurality of inwardly extending flexible flaps separated by radial slits meeting at the centre of the outlet. The slits are oriented relative to one another such that, in a process of injection moulding the plate from one edge, the mould material can flow to form the flaps without creating air pockets.

The orientation of the flaps and slits can therefore be of considerable importance in facilitating manufacture of the base and teats as a single integral unit.

The use of multiple flaps facilitates opening and closing of the outlets. However, preferably, three inwardly extending flexible flaps are provided at each outlet.

This provides good performance in use and facilitates moulding the plate without creating air pockets.

According to the present invention, there is also provided a method of constructing a shower handset having elastomeric teats, the method including moulding an elastomeric plate having a base with an upstream and a downstream surface and a plurality of teats extending from said downstream surface in directions which are parallel when the elastomeric plate is unstressed, providing a spray plate having an inner surface, an outer surface and a plurality of through holes corresponding to said teats, locating the elastomeric plate adjacent the spray plate with the downstream surface of said base being located adjacent said inner surface of said spray plate with said teats extending through said through holes and providing a support structure for holding the elastomeric plate adjacent said inner surface such that said base and at least a first one of said teats is deflected.

At least one deflection member may be provided between said downstream surface and said inner surface positioned radially inwardly or outwardly of said second array of teats and the support structure may be positioned so as to press said base against the inner surface such that the base is deflected around the deflection member and at least a first one of said teats is deflected.

Preferably, the first one of the teats, when deflected, does not extend in the direction of at least a second one of said teats.

According to the present invention, there is also provided a shower handset including an elastomeric plate having a base with an upstream and a downstream surface and a plurality of teats extending from said downstream surface in directions which are parallel when the elastomeric plate is unstressed and a spray plate having an inner surface, an outer surface and a plurality of through holes corresponding to said teats, the downstream surface of said base being located adjacent said inner surface of said spray plate with said teats extending through said through holes. The shower handset further includes a support structure for holding the elastomeric plate adjacent said inner surface such that said base and at least a first one of said teats is deflected.

Thus, for instance, if the elastomeric plate is caused to conform to a concave inner surface, the teats will be deflected accordingly.

Preferably, however, the shower handset includes at least one deflection member between said downstream surface and said inner surface positioned radially inwardly or outwardly of at least a first one of said teats wherein the support structure presses said base against the inner surface such that the base deflects around the deflection member and said first one of said teats is deflected.

Preferably, when deflected, the first one of the teats does not extend in the direction of at least a second one of the teats.

In this way, it is possible to produce all of the teats as a single moulded component. Since all of the teats extend in a parallel direction in the component as moulded, the elastomeric plate can be moulded straight in line of draw. In other words, the two halves of the mould may be separated in the direction of extent of the teats. It is not necessary to arrange a plurality of separate teats or to mould teats of one teat mat with different shapes according to their position. This allows the mould tool to be manufactured more easily and for the teats to be made with identical shapes.

When the elastomeric plate is installed in the handset, the teats are deflected by the support structure and deflection member to provide the desired spray pattern.

The plurality of teats may be provided as one or more arrays, for instance concentric annular arrays. The at least first one and at least second one of the teats may be provided in the same array. Alternatively, the at least first one and at least second one of the teats may be provided in respective concentric arrays of teats.

Respective deflection members may be provided for individual teats or groups of teats to deflect those teats or groups as required. However, where the at least first one of the teats is provided as an annular array, a single annular deflection member may be provided for the array so as to deflect the teats of that array all to the same angle of deflection. The angle of deflection is determined by the depth of the member.

By providing the deflection member on the inside of an array of teats, the outside of the teats are deflected towards the inner surface of the spray plate such that the teats are deflected to provide inwardly directed jets. On the other hand, by providing a deflection member on the outside of a teat, the corresponding jet is directed outwardly.

Preferably, the elastomeric plate further includes at least a third one of said teats, optionally in the form of a third concentric annular array, extending from the downstream surface and through corresponding ones of through holes, the shower handset further including at least one additional deflection member between the downstream surface and the inner surface and positioned radially inwardly or outwardly of the third one of the teats such that the base is deflected by the additional deflection member and the third one of the teats does not extend in the direction of the second one of the teats.

In this way, the same advantages may be achieved for additional arrays of teats.

Preferably, the third one of the teats does not extend in the direction of the first one of the teats.

Thus, a more widely varying spray pattern may be provided.

Preferably, the at least a third one of the teats forms a diverging spray pattern with respect to the at least a first one of the teats.

Thus, where a plurality of the third one of the teats form a third array, all of the jets of water produced by the third array of teats are directed outwardly with respect to the jets from an array of the first one of the teats.

Preferably, the at least a first one of the teats forms a diverging spray pattern with respect to the at least a second one of the teats.

Thus, where each of said first, second and third teats from respective arrays, each array may diverge at an angle different from the other arrays so as to provide a desirable and full spray pattern.

The deflection member may be provided as a separate component for insertion into the handset. However, the number of components are reduced and assembly is simplified if the deflection member is integral with either the spray plate or the base.

Preferably, it is provided integrally with the base, though it should be appreciated that the deflection members for different arrays need not all be formed on the same one of the spray plate and the base.

Preferably, the deflection member comprises one of an annular ridge and the edge of an annular profile of the base.

Either way, the step portion and, therefore, the difference in height cause the local area of the base from which the teat extends to be deflected to an angle.

Preferably, each of the teats defines a respective orifice such that the teats together form an outlet spray pattern and wherein the cross-sectional area of the orifices changes automatically in response to the flow rate.

### BRIEF DESCRIPTION OF THE DRAWINGS

FIG. 1 illustrates a shower handset in which the present invention may be embodied;

FIGS. 2(a) to (c) illustrates a nozzle teat embodying the present invention;

FIG. 3(a) and (b) illustrate operation of the teat of FIGS. 2(a) to (c);

FIG. 4(a) and (b) illustrate operation of an alternative embodiment of the present invention;

FIG. 5(a) and (b) illustrate operation of an alternative embodiment of the present invention;

FIG. 6(a) to (c) illustrate a teat embodying an alternative embodiment of the present invention;

FIGS. 7(a) and (b) illustrate operation of the teat of FIGS. 6(a) to (c);

FIGS. 8(a) to (c) illustrate an alternative embodiment of the present invention;

FIG. 9 is an exploded view of some of the component parts of the embodiment of FIGS. 8(a) to (c);

FIG. 10 illustrates a teat plate embodying the present invention;

FIG. 11 illustrates a spray plate for use with the teat plate of FIG. 10;

FIGS. 12(a) and (b) illustrate deflection of teats;

FIG. 13 illustrates preferred teat slit orientations; and

FIGS. 14(a) and (b) illustrate mould flow when forming flaps in orifices.

### DETAILED DESCRIPTION OF THE PREFERRED EMBODIMENTS

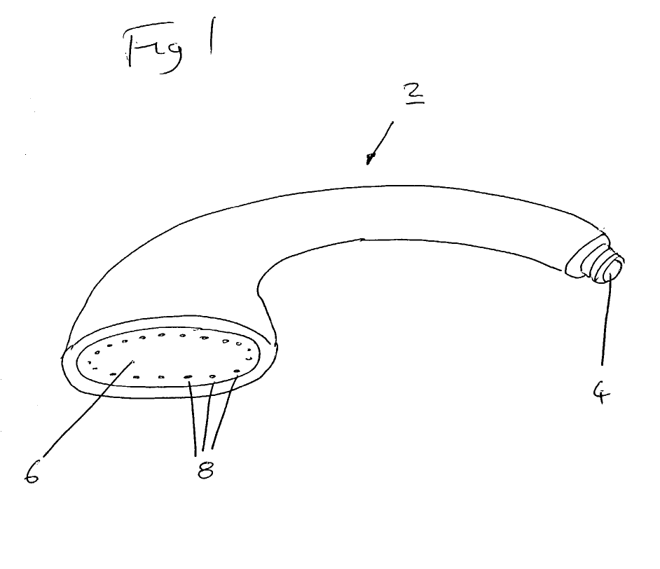

The invention will be more clearly understood from the following description, given by way of example only, with reference to the accompanying drawing. The present invention relates to a shower handset, for instance as illustrated in FIG. 1.

The shower handset 2 includes a water inlet 4, a spray plate 6 and a plurality of orifices 8 in the spray plate 6. Water is provided to the inlet 4 and exits from the handset 2 through the orifices 8 to form a predetermined spray pattern.

The following description is concerned with automatically changing the effective cross-sectional area of the orifices such that the handset produces a generally similar spray pattern over a wide range of flow rates. However, it is also possible to vary the shape and/or length of the orifices to vary their flow resistance. In particular, it is an object to avoid unnecessarily sharp jets and large pressure drops for high flow and to maintain aesthetically pleasing or focussed jets for low flow rates.

According to a first embodiment, the spray plate design uses elastomeric teats which are split into different segments along their length axis.

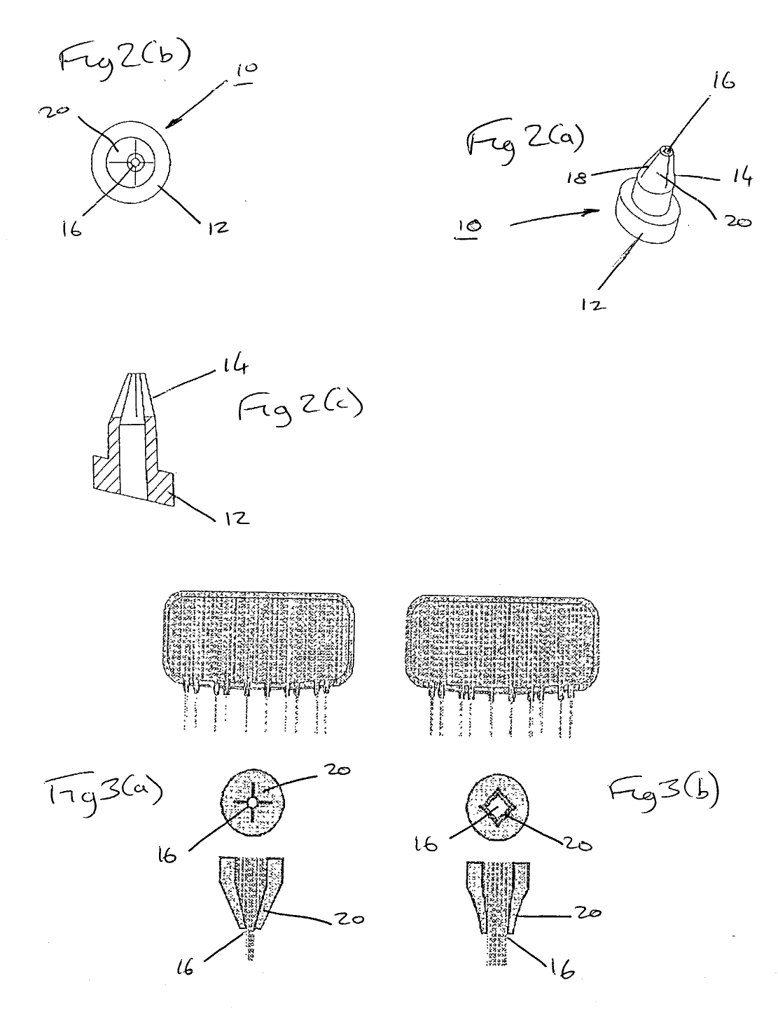

FIG. 2(a) illustrates an appropriate teat 10 and FIGS. 2(b) and (c) illustrate respectively a view from above and a cross-section along its length. The illustrated teat 10 is asymmetric and is intended to provide a flow path through the teat which is angled relative to its base. Nevertheless, it should be appreciated that symmetric teats could also be provided for perpendicular flow.

As illustrated, the teat 10 includes a base 12 which may be secured to a face plate and has a generally conical outer peripheral wall 14 which extends to an outlet 16. A plurality of axially extending slits 18 divide the conical wall into a plurality of interspersed flaps or segments 20.

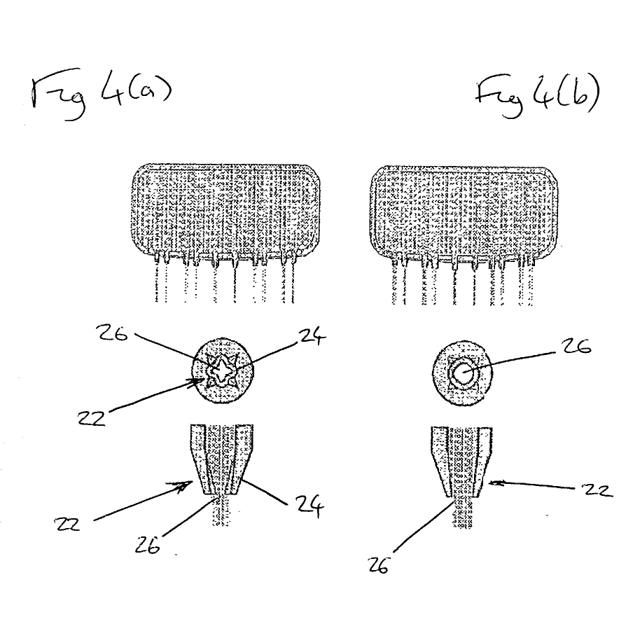

FIGS. 3(a) and (b) illustrate respectively schematic handsets and nozzles respectively for low flow rate and high flow rate. These nozzles include symmetric teats.

At low flow rates, the water pressure is insufficient to bend the different teat segments 20 apart. The outlet hole 16 is therefore relatively small and ensures the formation of a well-defined jet. At higher flow rates, the water pressure is sufficient to flex the different teat segments 20 apart. This action results in an increased spray hole diameter.

In the illustrated embodiment, the teat has an approximately constant peripheral wall thickness and, hence, has a generally conical outer form. However, it is sufficient for the inner passageway to be conical. Thus, the outer shape may take any appropriate form. Indeed, other embodiments might have inner passageways of different forms also.

Slits may be formed in the teats in-situ during the manufacture of the teat, e.g. by moulding. Alternatively, they may be introduced by cutting or structuring the teat in a suitable manner.

Depending on the application and the desired effects to be achieved, the number of slits in a teat may vary. It is proposed that teats with 2 to 4 slits should be used, since these are relatively easy to manufacture and provide adequate performance.

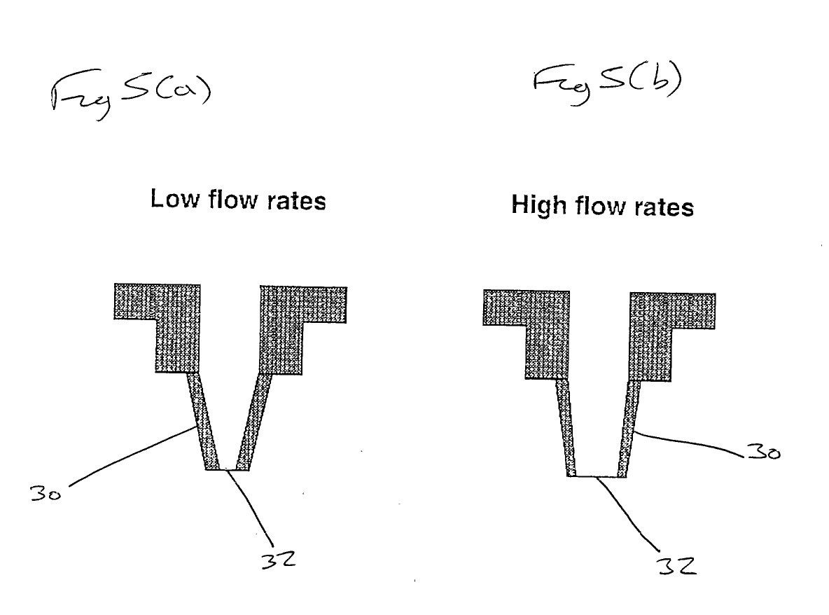

Rather than splitting the individual teats, the same effect can be achieved by including folds in the teats which enable the nozzle to open up with flow rate/water pressure. FIGS. 4(a) and (b) illustrate schematically a handset and nozzles respectively at low flow rates and high flow rates.

A generally conical peripheral wall 22 comprises a series of flaps 24 extending axially from the outlet 26.

As illustrated, for the higher flow rates, the flaps are deformed outwardly so as to increase the cross-sectional area of the outlet 26.

The teats can be manufactured from any elastomeric or deformable material. Preferred for the application in a shower handset is the use of neoprene, thermoplastic elastomer, liquid silicone or any rubber or rubber-like material.

The teats may be produced as individual units which are then assembled into the handset. Alternatively, sub assemblies combining several (or all) teats on a suitable backing plate or base may be manufactured to simplify the assembly process of the handset. Furthermore, the teats may be produced by overmoulding in a suitable part (e.g. the aperture plate) of handset.

The geometry and material parameters of the teat, together with the number or length of the slits/flaps determine the flexibility/spring constant of the different teat segments. These parameters may therefore be used to adjust and tailor the performance of the teats, in particular the change in the aperture size and function of water pressure/flow rate.

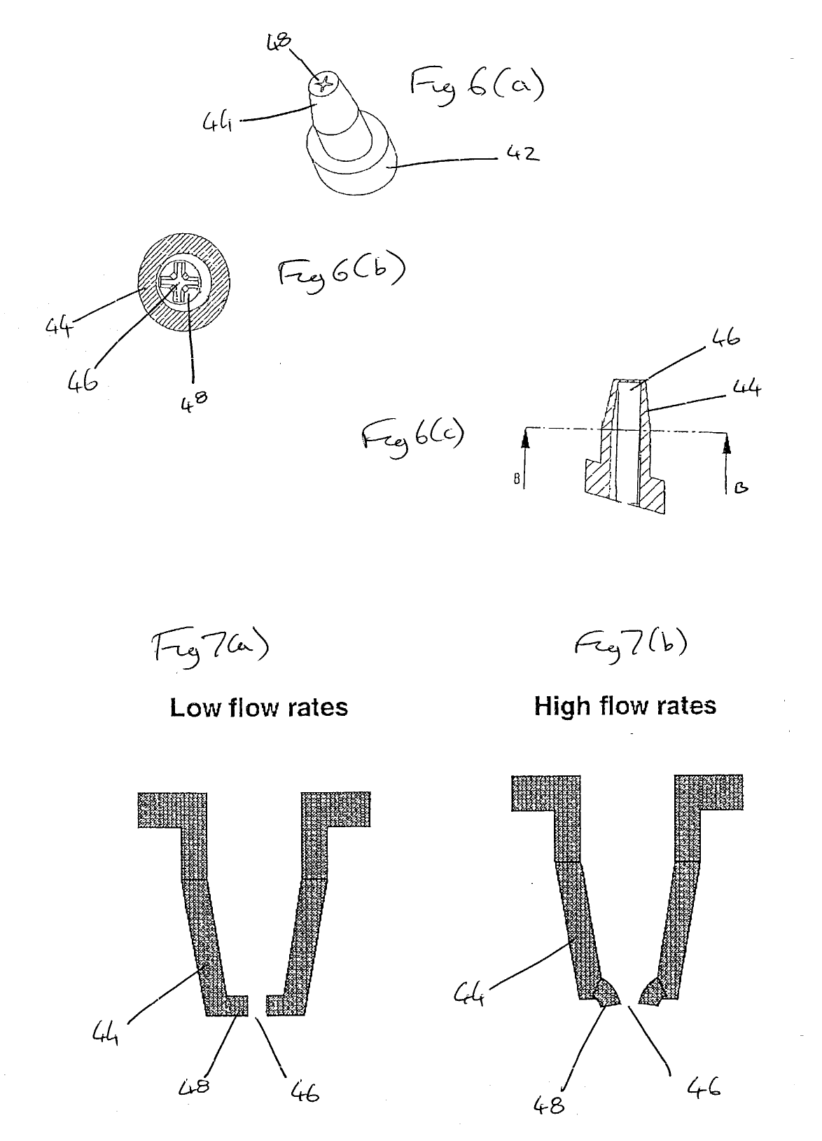

Rather than provide the folds 24 in the conical peripheral wall 26 of the orifice, it is possible to achieve a similar effect by allowing the conical wall itself to elastically deform. FIGS. 5(a) and (b) illustrate such a nozzle respectively for low flow rate and high flow rates.

As before, the nozzle includes a conical peripheral wall 30. However, the main difference is that the wall thickness is reduced to make it more flexible and deformable. Thus, at low flow rates, as illustrated in FIG. 5(a), the water pressure is too small to significantly stretch the teat. The outlet 32 is therefore small, resulting in a well formed and aesthetically pleasing jet. With increasing flow rate, the pressure difference across the wall 30 of the teat increases. Consequently, as illustrated in FIG. 5(b), the teat is stretched with the largest deformations occurring in the thinned-out sections. This stretching increases the size of the spray hole 32.

It should be-appreciated that, since the nozzle walls expand, it is not necessary for the teat to have an internal conical passageway.

The manufacturing materials and processes used to make these teats may be similar to those used for the split teats described above. However, it is proposed to use more flexible materials. In particular, the teats may be constructed of liquid silicone or other rubber or rubber-like materials having a relatively low Shore hardness, e.g. Shore A 20 to 50, preferably 25 to 40.

FIGS. 6(a), (b) and (c) illustrate an alternative design in which the outlet is partly closed off by a number of flaps.

The teat includes a base 42 and peripheral wall 44 defining a through channel to the outlet 46. Across the outlet 46 are a plurality of flaps 48 which partly close off the outlet at the end of the teat.

As illustrated in FIG. 7(a), at low flow rate the water pressure is insufficient to deform the flaps 48, resulting in a small spray hole 46. However, at high flow rate, as illustrated in FIG. 7(b), the water pressure is able to flex the flaps 48 outwards, thereby increasing the effective cross-sectional area of the outlet 46.

The number of flaps 48 in each nozzle, their geometry (e.g. width, length and thickness) and the material used to manufacture the nozzles depend on the chosen design and the desired performance. For example, the appearance of the spray as it leaves the nozzle can be tailored by changing the number of flaps. It is proposed to use 3 to 4 flaps per teat, since this gives adequate performance while being relatively easy to manufacture. In a preferred embodiment, 3 flaps are provided in each teat.

The geometry of the flaps, together with the thickness and the material parameters, such as hardness, determine the flexibility/spring constant of the flaps. It is also possible to include structural features, such as ribs and indentations, in the flaps to adjust their stiffness. These parameters can be used to adjust changes in the aperture size as a function of water pressure.

Preferably, the flaps are symmetric and therefore of equal size.

The manufacturing materials and processes used to make these teats are similar to those discussed above. It is proposed that the teats be made from liquid silicone with a Shore hardness of Shore A30 to 60, preferably in the region of 40, since this performs well. However, other elastomeric, flexible or deformable material with different hardnesses may also be used.

Although not illustrated, a variation to this embodiment is to provide the flaps directly in the orifices of the spray plate without the use of teats.

According to a further embodiment, the size of the spray aperture may be varied by inserting a pin into it.

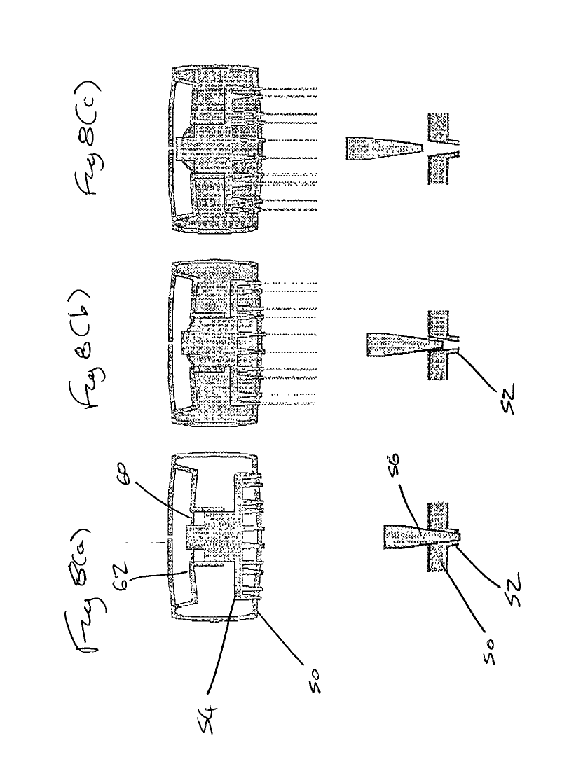

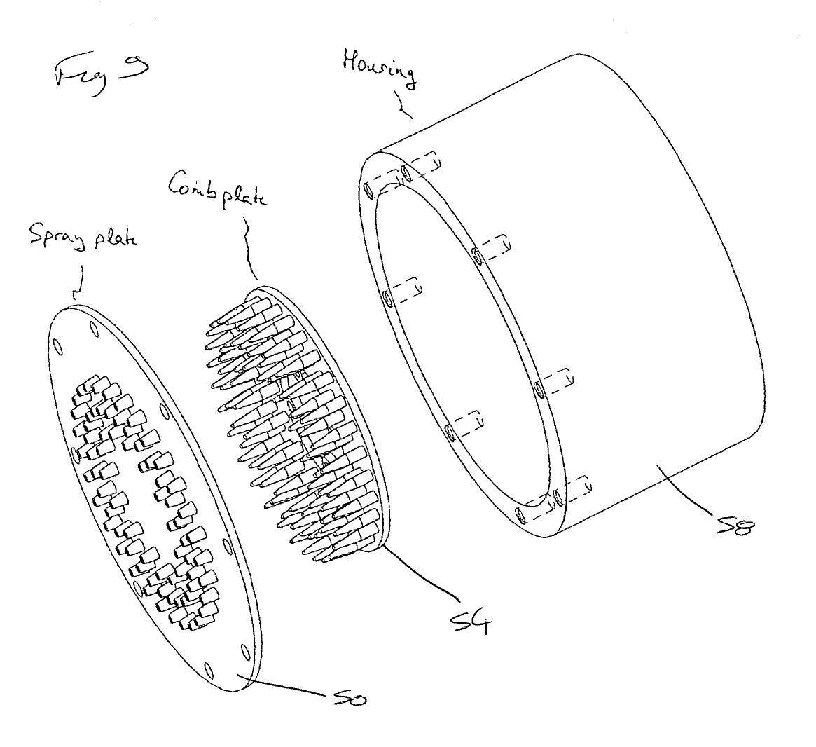

FIGS. 8(a), (b) and (c) illustrate a schematic shower handset and nozzle respectively for no flow, small flow and large flow.

As illustrated, the spray plate 50 is formed with a series of relatively large openings 52. These openings 52 may be, as illustrated, holes in an aperture plate or, alternatively, teats. Mounted behind the spray plate 50 is an additional plate 54 with a number of pins 56. This may be described as a comb plate. Each of the plates 56 is associated with a respective spray hole 52 and the spray openings 52 and the pins 56 are tapered.

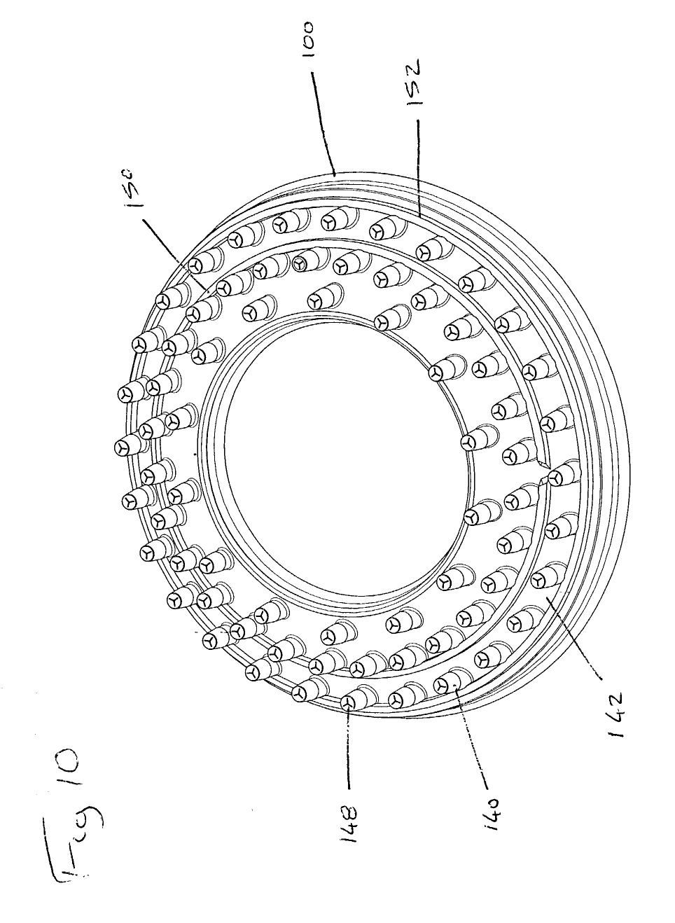

Penetration of the pins 56 into the spray holes 52 varies with the flow rate. Hence, the “apparent” size of the outlet aperture can be varied as a function of flow rate. Each opening in the spray plate may be associated with one pin. Alternatively, it is possible to adjust a sub-set of the openings in the spray plate by the proposed mechanism. FIG. 9 illustrates a spray plate 50 with a comb plate 54 to be housed in a housing 58 of the shower handset.

In the preferred embodiment, movement of the comb plate 54 with respect to the spray plate 50 is achieved by means of a diaphragm 60 which deforms as a function of flow rate. The comb plate 54 is rigidly attached to the diaphragm 60. The diaphragm 60 is mounted on the back top 62 of the handset opposite the aperture plate 50 and provides a “deformable” seal between the inside of the handset and the surrounding environment. With increasing flow rate, the water pressure in the handset increases, flexing the diaphragm 60 outwards and hence pulling the comb plate 54 away from the spray plate 50. As a consequence, the effective cross-sectional area of the outlet 52 increases in size.

Rather than merely relying on the elastic forces induced in the diaphragm 60 due to the deformation by a change in water pressure, it is also possible to include a spring in the design to cause the diaphragm 60 and comb plate 54 to move to their initial position should the water pressure be restored to its initial value.

The design may include a guide to align the comb plate 54 with respect to the spray plate 50. The diaphragm 60 may be made from rubber or any other flexible deformable material. Alternatively, any other suitable mechanism, which deforms as a function of the water pressure in the handset, may be used to move the comb plate 54 with respect to the spray plate 50. For example, a bellows or a so-called rolling diaphragm may be used in place of the diaphragm.

As an alternative to the diaphragm, a balloon may be provided in the handset. As the pressure/flow increase, the shape and volume of the balloon changes and the pins move in accordance to this shape/volume change.

Alternatively, a spring-loaded flap may be provided in the handset. The flap extends into the flow. The flow exerts a certain force on the flap which is counteracted by the spring force. As the flow changes, the force on the flap and therefore the orientation of the flap changes. Again, this change in orientation can be used to move the pins with respect to the orifices. Similarly to the flap, one can imagine a vane or turbine in the flow acting in a similar manner.

Hence, it can be envisaged that the comb plate 54 is moved relative to the spray plate 50 by means of a counter lever, vane or turbine acting against a spring or an elastic member. As the water pressure changes, the force on the mechanism changes and, hence, its position/size. The change in position/size is used to move the comb plate 54 relative to the spray plate 50.

Elastomeric teats are preferably formed together integrally with the base as an elastomeric plate or teat plate.

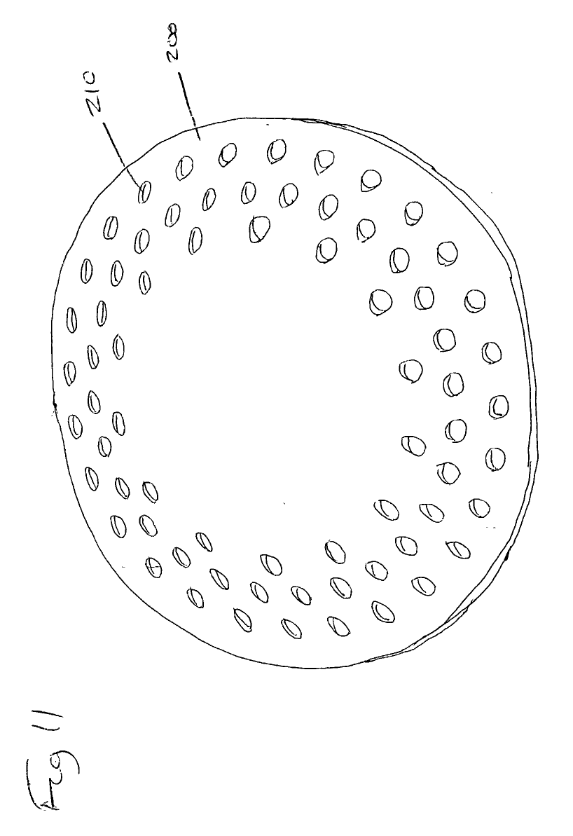

FIG. 10 illustrates an elastomeric plate 100 formed of a base 142 with three concentric annular arrays of teats 140. In the illustrated embodiment, the teats are each provided with three flaps 148 which operate in the manner described with reference to FIGS. 6(a) to (c). However, it will be appreciated from the following that the preferred method of construction and assembly of the teat plate and shower handset can also be applied to any of the other teats described above or to conventional teats.

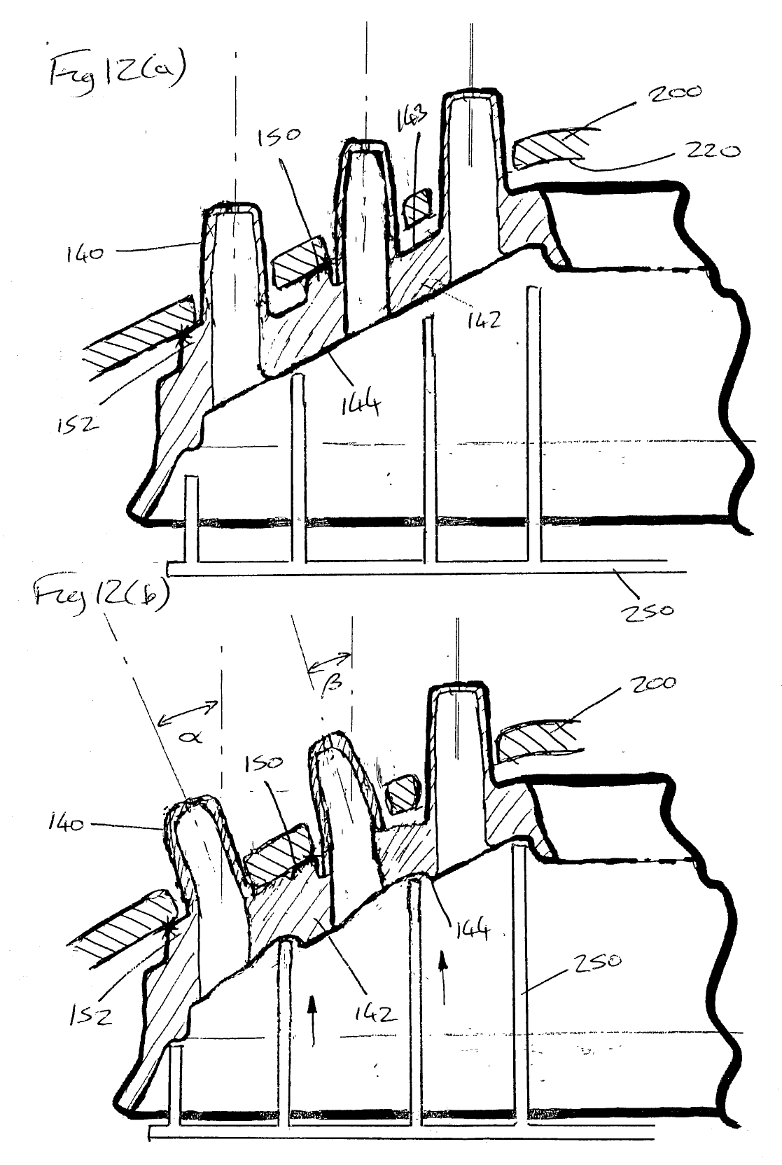

FIG. 11 illustrates the outer surface of a corresponding spray plate 200 for a shower handset. The spray plate 200 has aperture 210 corresponding to the teats 140 of the plate 100 such that, with the plate 100 located behind the spray plate 200, the teats 140 extend through the apertures 210. The spray plate 200 is preferably made of a material harder than that of the teat plate 100 and forms the outer surface of the shower handset.

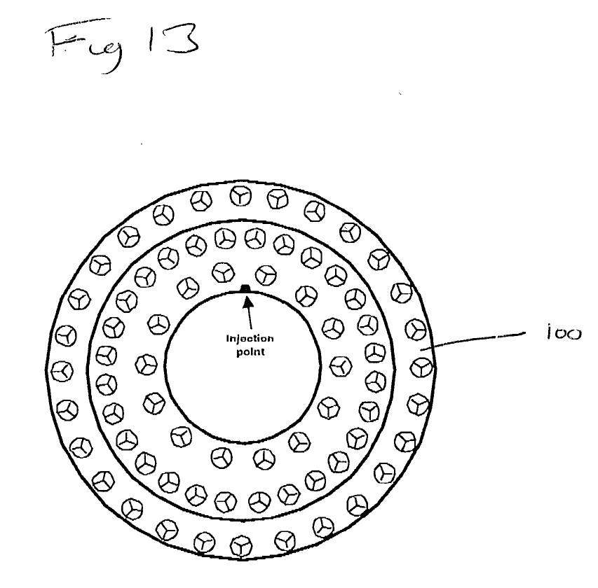

FIG. 12(a) illustrates schematically a partial cross-section of the teat plate 100 provided in position behind the spray plate 200. In particular, a downstream, surface 143 of the base 142 is located adjacent the inner surface 220 of the spray plate 200 such that the teats 140 extend through the apertures 210.

As illustrated, a support structure 250 within the shower handset is not fully installed and has not yet contacted the upstream surface 144 of the base 142.

In this state, it will be seen that the elastomeric plate is in a relaxed, unstressed or undeformed state and the teats all extend in the same direction. In particular, the walls of the teats are generally parallel or (as described above) conical so as to allow a straight in line draw during the moulding process. In other words, the elastomeric plate may easily be moulded with two halves of a mould which are drawn apart in the direction of the teats.

As illustrated in FIG. 10, a concentric ridge 150 is provided on the downstream surface 143 of the base adjacent to the middle array of teats 140. Similarly, at the edge of the teat plate, the profile of the downstream surface 143 is raised so as to provide an edge or shoulder 152 adjacent one side of the outer annular array of teats 140.

As illustrated in FIGS. 12(a) and (b) these raised portions 150 and 152 abut the inner surface 220 of the spray plate 200 and form what will be described as deflection members.

The base 142 is part of the elastomeric plate and, hence, is formed of a flexible material. Therefore, as the support structure 250 presses against the upstream surface 144, the base 142 will be pressed and deflected outwardly towards the inner surface 220 of the spray plate 200.

Because the members 150, 152 already abut the inner surface 220 of the spray plate 200, the base 142 is unable to move or deflect the base at those positions. On the other hand, on the opposite side of the teats, effectively a space is left into which the base 142 may be deflected. As a result, as illustrated in FIG. 12(b), for the areas of the base 142 around the teats, the base 142 is deflected at an angle. As a result, the teats 140 are similarly deflected so as to extend at an angle relative to their original orientation.

Preferably, as illustrated, the structure 250 presses on the upstream surface 144 at positions of the base 142 on the opposite side of teats from the members 150 and 152. This ensures that the base 142 and, hence, the teats are deflected appropriately.

By varying the depth of the deflection members 150 and 152, i.e. ridges or edges of profiles of the downstream surface 143, the amount by which the teats are deflected can also be varied. Hence, as illustrated, it is possible to deflect the outer array by an angle a which is greater than the deflection angle β of the middle array. A fully diverging spray pattern may thus be formed using an elastomeric plate produced with a simple moulding process.

The depth of the members 150,152 may be different for different teats so as to provide a more varied spray pattern. Indeed, the members 150,152 could be provided as separate components. However, it is preferable, for ease of assembly, to provide the members integrally with either the elastomeric plate or the spray plate.

In the illustrated embodiment, of course, the members are formed integrally with the elastomeric plate.

It should be appreciated that the illustrated embodiment uses circular arrays of teats. However, reference here to annular arrays, etc is intended in the most general sense and includes also elliptical, oblong, square arrays, etc. Other irregular and alternative teat arrangements are also possible.

Indeed, the teats may be deflected on an individual basis and, hence, need not be considered as arrays. One annular ring of teats could include individual teats to be deflected by different amounts.

In another embodiment, the support structure can take the form of features between the teat plate 100 and spray plate 200 which cause the teat plate 100 to be deflected by virtue of its own resilience against the inner surface 220 of the spray plate. For instance, by locating the teat plate 100 between members having a smaller spacing than the relaxed diameter of the teat plate 100, the teat plate 100 will be biassed in an axial direction, for instance towards the inner surface 220.

When moulding a teat plate 100 as illustrated in FIG. 10, mould material is introduced into the mould at one side of the mould, for instance at an inner or outer edge of the plate 100, and travels progressively through the space within the mould so as to fill it. However, if pockets exist in the mould, air can become trapped, such that the resulting teat plate 100 is incomplete at the locations of the air pockets. This is particularly of concern in moulding the relatively small and delicate flaps 148 of the teats 140.

Furthermore, the slits defining the flaps 148 should be oriented to ensure that the entire space within the mould is filled successfully.

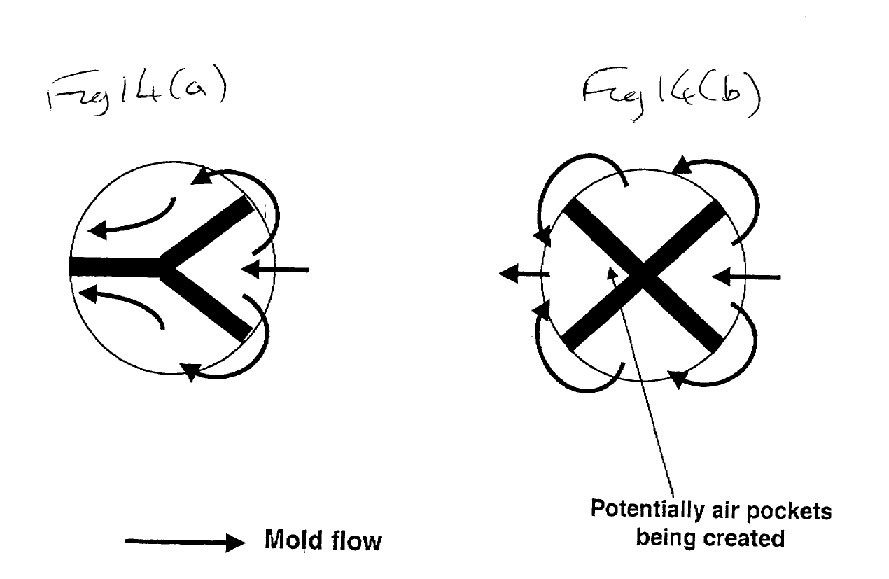

FIG. 13 illustrates the orientation required for a pattern having three concentric annular arrays of teats having 28, 28 and 14 teats respectively. As the injection material flows from the injection point, it travels into each of the spaces for forming flaps without leaving any air pockets. It will be apparent that the orientation can be modified for other arrangements.

Referring to FIG. 14(a), it will be seen that, on encountering a teat the mould material flows up towards the top of the cone. Due to the mould flow around the tool, certain portions of the cone fill quicker than others, creating a leading edge of the mould flow as it fills the cone and creates the teat. The orientation of the leading edge and therefore the way in which the teat cone fills depends on the position of the teat within the tool.

Should the mould flow be such that it fills the “leg” portion of the “Y” first, the material would flow from two sides across the “top end” of the Y in order to create the top flap. However, due to this flow pattern, it is likely that air gets trapped at the far end of the top flap (e.g. if the two streams, which rush across the top of the Y combine before the top flap is completely filled, the trapped air can no longer escape any more and a air pocket is formed at the end of this flap). This air cannot be pressed out of the tool as it is enclosed by the tool on one side and mould material rushing across the top flap on the other side.

The “Y's” therefore are orientated to ensure that the “leading edge” of material on each cone does not fill first at the “leg” portion of the “Y” as this would cause the material to rush across the top “flap” of the cone and “air-trap/short fill” opposite (thus reducing the desired control of flow through the nozzle).

In this regard, it is proposed to provide each teat 140 with 3 flaps 148. This is because the likelihood of air traps and air pockets being formed is higher with four flaps than with three. From the point of view of manufacturability, three flaps are therefore preferred.

As can be seen from FIG. 14(b), in a four-flap design, there is no teat orientation which will prevent the “rush” of mould material across a flap from two sides. Hence, the likelihood of trapping air at the end of a flap is very high. The three-flap design avoids this problem if the teat orientation is chosen correctly.

We claim

1. A shower handset including:
an inlet for water; and
at least one orifice for providing an outlet spray pattern; wherein
the flow resistance of the orifice changes automatically in response to the flow rate.

2. A shower handset according to claim 1 wherein the cross-sectional area of the orifice changes automatically in response to the flow rate.

3. A shower handset according to claim 2 wherein at least one of said at least one orifice includes an elastomeric teat having an outlet at one end.

4. A shower handset including:
an elastomeric plate having a base with an upstream and a downstream surface and a plurality of teats extending from said downstream surface in directions which are parallel when the elastomeric plate is unstressed;
a spray plate having an inner surface, an outer surface and a plurality of through holes corresponding to said teats, the downstream surface of said base being located adjacent said inner surface of said spray plate with said teats extending through said through holes;
the shower handset further including:
a support structure for holding the elastomeric plate adjacent said inner surface such that said base and at least a first one of said teats is deflected.

5. A shower handset according to claim 4 further including:
at least one deflection member between said downstream surface and said inner surface positioned radially inwardly or outwardly of said at least a first one of said teats; wherein
the support structure presses said base against the inner surface such that the base deflects around the deflection member and said first one of said teats is deflected.

6. A shower handset according to claim 5 wherein said first one of said teats when deflected does not extend in the direction of at least a second one of the teats.

7. A shower handset according to claim 6 wherein:
the elastomeric plate further includes at least a third one of said teats extending from said downstream surface and through corresponding ones of said through holes, the shower handset further including:
at least one additional deflection member between said downstream surface and said inner surface and positioned radially inwardly or outwardly of said third one of said teats wherein the base is deflected around the additional deflection member and said third one of the teats does not extend in the direction of said second one of said teats.

8. A shower handset according to claim 7 wherein said third one of said teats does not extend in the direction of the first one of said teats.

9. A shower handset according to claim 8 wherein said at least a third one of said teats forms a diverging spray pattern with respect to the said at least a first one of said teats.

10. A shower handset according to claim 6 wherein said at least a first one of said teats forms a diverging spray pattern with respect to said at least a second one of said teats.

11. A shower handset according to claim 5 wherein said deflection member(s) is integral with said base.

12. A shower handset according to claim 5 wherein said deflection member(s) comprises one of an annular ridge and the edge of an annular profile of the base.

13. A shower handset according to claim 4 wherein at least one of said plurality of teats forms a respective orifice from an outlet at one end such that the teats together form an outlet spray pattern and wherein the cross sectional area of the orifices changes automatically in response to the flow rate.

14. A shower handset according to claim 2 wherein the cross-sectional area increases with increasing flow rate.

15. A shower handset according to claim 3 wherein the cross-sectional area increases with increasing flow rate and said elastomeric teat includes a peripheral wall defining an inner passageway feeding said outlet.

16. A shower handset according to claim 15 wherein said inner passageway has a progressively reduced cross sectional area towards said one end.

17. A shower handset according to claim 15 wherein the peripheral wall of each teat includes a plurality of slits extending axially from the outlet so as to define a plurality of interspersed flaps which deflect outwardly with increasing water flow rate.

18. A shower handset according to claim 15 wherein the peripheral wall of each teat includes a plurality of folds extending axially from the outlet such that, with increasing water flow rate, the cross-sectional area of the outlet and the peripheral wall proximate the outlet increase.

19. A shower handset according to claim 15 wherein the peripheral wall of each teat is of a relatively reduced thickness such that, with increasing water flow rate, the peripheral wall flexes outwardly and the cross-sectional area of the outlet increases.

20. A shower handset according to claim 15 wherein the outlet is at least partly covered by a plurality of inwardly extending flexible flaps which flex away from the outlet with increasing flow rate so as to increase the cross-sectional area of the outlet flow path.

21. A shower handset according to claim 20 wherein three inwardly extending flexible flaps are provided symmetrically for each outlet separated by three radial slits meeting at the centre of the outlet.

22. A shower handset according to claim 3 wherein the elastomeric teats have a Shore hardness of 20 to 70, preferably in the region of 40.

23. A shower handset according to claim 2 wherein said at least one orifice forms an outlet at least partly covered by a plurality of inwardly extending flexible flaps which flex away from the orifice with increasing flow rate so as to increase the cross-sectional area of the outlet flow path.

24. A shower handset according to claim 23 wherein three inwardly extending flexible flaps are provided symmetrically for each outlet separated by three radial slits meeting at the centre of the outlet.

25. A shower handset according to claim 23 wherein the flexible flaps have a Shore hardness of 20 to 70, preferably in the region of 40.

26. A shower handset according to claim 1 wherein at least one of said orifices includes a pin within the handset, the pin being movable into and out of the orifice in response to flow rate.

27. A shower handset according to claim 26 wherein the pin moves progressively into the orifice with decreasing flow rate.

28. A shower handset according to claim 26 wherein the pin is moved by means of at least one of a diaphragm, a rolling diaphragm and a bellows which deforms as a function of flow rate.

29. A shower handset according to claim 26 wherein at least one of the pin and the orifice is tapered.

30. A shower teat plate for use in a shower handset according to claim 1 including
a base; and
a plurality of teats extending from the base, each teat having an outlet at the end distal from the base, the outlet being at least partly covered by a plurality of inwardly extending flexible flaps separated by radial slits meeting at the centre of the outlet; wherein
the slits are oriented relative to one another such that in a process of injection moulding the plate from one edge, the mould material can flow to form the flaps without creating air pockets.

31. A shower teat plate according to claim 30 wherein three inwardly extending flexible flaps are provided at each outlet.

32. A shower teat plate according to claim 31 wherein the slits are oriented such that as the leading edge of the mould flow approaches a respective teat, the leading edge is generally perpendicular to a radial slit of the respective teat on the far side of the respective teat from the leading edge.

33. A shower teat plate according to claim 31 wherein the slits are oriented such that the leading edge of the mould flow approaches a respective teat with two adjacent slits of the respective teat on the side of the leading edge angled generally symmetrically either side of the direction of flow.

34. A shower teat plate according to claim 31 having three concentric annular arrays of teats having respectively 28, 28 and 14 teats wherein the slits are oriented as illustrated in FIG. 13.

35. A method of constructing a shower handset having elastomeric teats, the method including:
moulding an elastomeric plate having a base with an upstream and a downstream surface and a plurality of teats extending from said downstream surface in directions which are parallel when the elastomeric plate is unstressed;
providing a spray plate having an inner surface, an outer surface and a plurality of through holes corresponding to said teats;
locating the elastomeric plate adjacent the spray plate with the downstream surface of said base being located adjacent said inner surface of said spray plate with said teats extending through said through holes;
providing a support structure for holding the elastomeric plate adjacent said inner surface such that said base and at least a first one of said teats is deflected.
